(19) United States
(12) Patent Application Publication
(10) Pub. No.: US 2013/0187890 A1
(43) Pub. Date: Jul. 25, 2013

(54) USER INTERFACE APPARATUS AND METHOD FOR 3D SPACE-TOUCH USING MULTIPLE IMAGING SENSORS

(71) Applicant: Mun Ki PAEG, Gwangmyung (KR)

(72) Inventor: Mun Ki PAEG, Gwangmyung (KR)

(21) Appl. No.: 13/354,906

(22) Filed: Jan. 20, 2012

(51) Int. Cl. G06F 3/042

(52) U.S. Cl. 345/175

(57) ABSTRACT

A user interface apparatus and method for 3D space-touch using multiple imaging sensors is provided to control an output display and provide a 3D input information without a separate input device, with an output display controller device analyzing a video data captured by the imaging sensors installed at one side and the other side of the output display, by the output display controller device generating an output display control signal and a mapping information and transmitting the signal and the mapping information to the output device if a user's motion is determined to be a motion of inputting a controlling signal (such as an act of double-clicking a part of the output display) corresponding to the output display control signal using the user's hand or a pointing stick (such as a ballpoint pen, a wood stick, etc.), thereby making users interested and providing users with convenience.

### BACKGROUND OF THE INVENTION

1. Technical Field

The present invention relates to a user interface apparatus and method for three dimensional (3D) space-touch using multiple imaging sensors and, more particularly, a user interface apparatus and method for touch input in 3D space which can control an output display and provide a 3D input information without a separate input device, with an output display controller device analyzing a video data captured by the imaging sensors installed at one side and the other side of the output display while the output device outputs a visual display, by the output display controller device generating an output display control signal and a mapping information and transmitting the signal and the mapping information to the output device if a user's motion is determined to be a motion of inputting a controlling signal (such as an act of double-clicking a part of the output display) corresponding to the output display control signal using the user's hand or a pointing stick (such as a ballpoint pen, a wood stick, etc.), thereby making users interested and providing users with convenience.

2. Description of the Related Art

The present invention relates to a user interface apparatus and method for 3D space-touch using multiple imaging sensors.

Conventionally, a corded or cordless keyboard or a mouse is used for pointing at a specific location on a monitor or on a presentation screen.

A mouse is a pointing device developed as a standard input device of Macintosh by Apple computer Inc., functioning by detecting two dimensional (2D) motions relative to its supporting surface, being used with most of personal computing devices nowadays.

Recently, other pointing devices such as laser pointer are also in use. These new pointing devices can be used for pointing at a specific location on an output screen. But in most cases these devices cannot be used for inputting data.

And glove-type data input devices have been recently developed and commercialized. This type of device functions by capturing movements of a hand or fingers in 3D space via a wired glove worn on the hand and translating the movements to meanings if the movements correspond to preset gestures.

However, all of the devices mentioned above have their limits. For example, a mouse needs a supporting surface, thus being limited space-wise. New types of pointing devices such as laser pointer cannot be used for inputting data. And, most of the input devices require a separate apparatus, such as a mouse, a glove or a keyboard, thus increasing costs. Needing a separate apparatus means more costs if the apparatus is connected via a wireless network because a wireless communication device is required. Furthermore, a person with a disability may not use such an apparatus.

### SUMMARY OF THE INVENTION

Accordingly, the present invention has been devised to solve the above-mentioned problems, and an object of the present invention is to provide a user interface apparatus and method for 3D space-touch using multiple imaging sensors which can control an output display and provide a 3D input information without a separate input device, with an output display controller device analyzing a video data captured by the imaging sensors installed at one side and the other side of the output display, by the output display controller device generating an output display control signal and a mapping information and transmitting the signal and the mapping information to the output device if a user's motion is determined to be a motion of inputting a controlling signal (such as an act of double-clicking a part of the output display) corresponding to the output display control signal using the user's hand or a pointing stick (such as a ballpoint pen, a wood stick, etc.), thereby making users interested and providing users with convenience.

In order to achieve the above objects, the present invention provides a user interface apparatus for 3D space-touch using multiple imaging sensors, the apparatus comprising a first imaging sensor installed on one side of an output display capturing a video of a predetermined area, generating a first video, and transmitting the first video to an output display controller device; a second imaging sensor installed on the other side of the output display capturing a video of a predetermined area, generating a second video, and transmitting the second video to the output display controller device; a storage part storing pointing stick movement data and finger movement data for controlling an output display; and an output display controller device configured to perform operations comprising receiving the first video and the second video, analyzing outlines and RGB values of the first video or the second video to extract fingers or a pointing stick, recognizing movements of the extracted fingers or the extracted pointing stick and adjudging whether the movements of the fingers or the pointing stick correspond to the movement data stored in the storage part, generating an output display control signal corresponding to the movements of the fingers or the pointing stick if the movements of the fingers or the pointing stick correspond to the movement data stored in the storage part, extracting eyes and the fingers or extracting the pointing stick from a first video and a second video respectively, determining a mapping point pointed by a user on an output display based on locations of the eyes and the fingers or a location of the pointing stick, and transmitting the output display control signal, the mapping point and a 3D input information extracted from the fingers or the pointing stick to an output device.

And it is preferred that the output display controller device performs operations comprising, if the movements of the fingers or the pointing stick correspond to the movement data stored in the storage part, receiving a first video and a second video captured at the moment which the movements of the fingers or the pointing stick are inputted, extracting outlines and RGB values from the first video, determining locations of the left eye, the right eye and the fingers or a location of an end point of the pointing stick of the first video, and calculating 2D coordinate values of the left eye, the right eye and the fingers or of the end point of the pointing stick of the first video using the location(s); extracting outlines and RGB values from the second video, determining locations of the left eye, the right eye and the fingers or a location of an end point of the pointing stick of the second video, and calculating 2D coordinate values of the left eye, the right eye and the fingers or of the end point of the pointing stick of the second video using the location(s); calculating 3D coordinate values of the right eye by trigonometry using the 2D coordinate values of the right eye of the first video and the second video, calculating 3D coordinate values of the left eye by trigonometry using the 2D coordinate values of the left eye of the first video and the second video, and calculating 3D coordinate values of the fingers or of the end point of the pointing stick by trigonometry using the 2D coordinate values of the fingers or of the end point of the pointing stick of the first video and the second video; setting the 3D coordinate values of the right eye or of the left eye as a first point, setting the 3D coordinate values of the fingers or of the end point of the pointing stick as a second point, and determining a mapping point as a point at which the output display and an extended line connecting the first point and the second point meet.

And, in order to achieve the above objects, the present invention also provides an input method for the user interface apparatus for 3D space-touch using multiple imaging sensors, the input method comprising the steps of (a) a first imaging sensor and a second imaging sensor, installed respectively on one side and the other side of an output display, capturing a video of a predetermined area, generating a first video and a second video respectively, and transmitting the first video and the second video to an output display controller device respectively; (b) the output display controller device analyzing outlines and RGB values of the first video or the second video received at step (a) to extract fingers or a pointing stick; (c) the output display controller device recognizing movements of the fingers or the pointing stick extracted at step (b) and adjudging whether the movements of the fingers or the pointing stick correspond to a preset movement controlling an output display; (d) the output display controller device generating an output display control signal corresponding to the movements of the fingers or the pointing stick, if the movements of the fingers or the pointing stick correspond to the preset movement controlling an output display as a result of step (c); (e) the output display controller device receiving a first video and a second video captured at the moment which the movements of the fingers or the pointing stick are inputted, analyzing outlines and RGB values of the first video and the second video, determining locations of the eyes and the fingers or a location of an end point of the pointing stick, and determining a mapping point pointed by a user based on the location(s), if the movements of the fingers or the pointing stick correspond to the preset movement controlling an output display as a result of step (c); and (f) the output display controller device transmitting the output display control signal, the mapping point and a 3D input information extracted from the fingers or the pointing stick to an output device.

And, in the above input method, it is preferred that the step (e) comprises the steps of (e1) the output display controller device receiving a the first video and the second video, if the movements of the fingers or the pointing stick correspond to the preset movement controlling an output display as a result of step (c); (e2) the output display controller device extracting outlines and RGB values from the first video and the second video received at step (e1), and determining locations of the left eye, the right eye and the fingers or a location of an end point of the pointing stick; (e3) the output display controller device calculating 2D coordinate values of the left eye, the right eye and the fingers or of the end point of the pointing stick of the first video using the location(s) determined at step (e2), and calculating 2D coordinate values of the left eye, the right eye and the fingers or of the end point of the pointing stick of the second video using the location(s) determined at step (e2); (e4) the output display controller device calculating 3D coordinate values of the right eye by trigonometry using the 2D coordinate values of the right eye of the first video and the second video, calculating 3D coordinate values of the left eye by trigonometry using the 2D coordinate values of the left eye of the first video and the second video, and calculating 3D coordinate values of the fingers or of the end point of the pointing stick by trigonometry using the 2D coordinate values of the fingers or of the end point of the pointing stick of the first video and the second video; and (e5) the output display controller device setting the 3D coordinate values of the right eye or of the left eye as a first point, setting the 3D coordinate values of the fingers or of the end point of the pointing stick as a second point, and determining a mapping point as a point at which the output display and an extended line connecting the first point and the second point meet.

Other objectives and desires may become apparent to one of skill in the art after reading the below disclosure and viewing the associated figures.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a system diagram schematically showing a user interface apparatus for 3D space-touch using multiple imaging sensors according to a preferred embodiment of the present invention;

FIG. 2 is a block diagram showing internal composition of the user interface apparatus for 3D space-touch using multiple imaging sensors according to a preferred embodiment of the present invention;

FIG. 3 is a diagram illustrating a process flow of the user interface apparatus for 3D space-touch using multiple imaging sensors according to a preferred embodiment of the present invention;

FIG. 4 is a diagram illustrating a way of determining a 3D mapping point according to a preferred embodiment of the present invention; and

FIG. 5 is a diagram for equation 1.

### DESCRIPTION OF THE PREFERRED EMBODIMENTS

Embodiments of the present invention will be described in detail with reference to the accompanying drawings.

Various objects, advantages and features of the invention will become more apparent from the following detailed description of the embodiments taken in conjunction with the accompanying drawings.

Although the preferred embodiments of the present invention are provided for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention will be clearly defined by the appended claims. Throughout the accompanying drawings, the same reference numerals are used to designate the same or similar components.

Hereinafter, preferred embodiments of the present invention will be described in detail with reference to the attached drawings which illustrate a user interface apparatus for 3D space-touch using multiple imaging sensors.

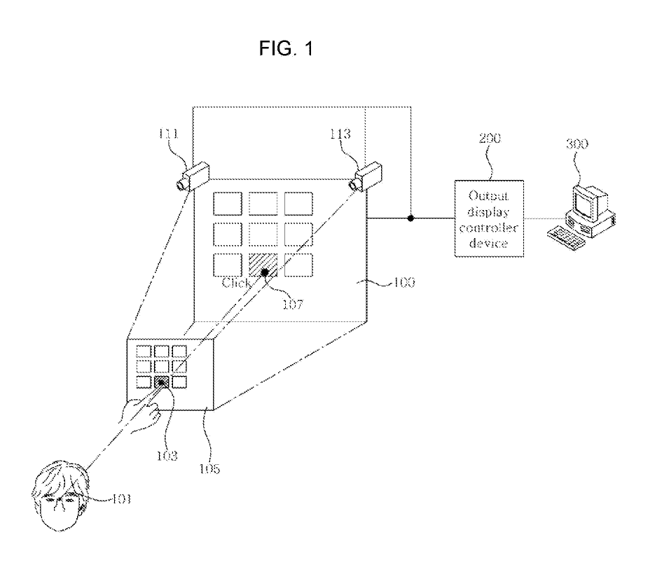

FIG. 1 is a system diagram schematically showing a user interface apparatus for 3D space-touch using multiple imaging sensors according to a preferred embodiment of the present invention.

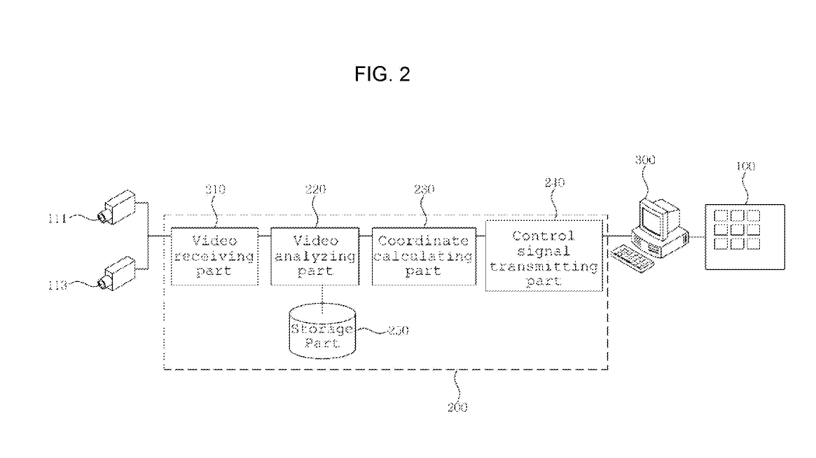

And FIG. 2 is a block diagram showing internal composition of the user interface apparatus for 3D space-touch using multiple imaging sensors according to a preferred embodiment of the present invention.

With reference to FIG. 1 and FIG. 2, the present invention provides the user interface apparatus comprising an output display 100, a first imaging sensor 111, a second imaging sensor 113, an output display controller device 200 and an output device 300.

Here, the output device 300 is connected to the output display 100 displaying a video. More particularly, the output display 100 can be a screen, and the output device 300 can be configured to have the output display 100 play a video from the output device 300 by using a device such as a beam projector. Or, the output device 300 can be connected to the output display 100 via a device such as a cable without using a device such as a beam projector.

The first imaging sensor 111, which is installed on one side of an output display, captures a video of a predetermined area, generates a video, and transmits the video to a video receiving part 210 within the output display controller device 200.

And, the second imaging sensor 113, which is installed on the other side of the output display, captures a video of a predetermined area, generates a video, and transmits the video to the video receiving part 210 within the output display controller device 200.

Meanwhile, the output display controller device 200 comprises a storage part 250, a video receiving part 210, a video analyzing part 220, a coordinate calculating part 230 and a control signal transmitting part 240.

Here, the storage part 250 stores pointing stick (such as a ballpoint pen or a wood stick, etc.) movement data or finger movement data controlling an output display. For example, the movement data can include “A hand shape, with only an index finger stretched out, moving twice in a set period time (e.g. 1 second) is adjudged as a double click”, “A hand shape, with all five fingers stretched out, moving five times in a set period time (e.g. 1 second) is adjudged as a signal to close current screen” or “A pointing stick, moving twice in a set period time (e.g. 1 second) is adjudged as a double click”, and so on. According to size of data to be stored in the storage part 250, a wide variety of storage medium such as EPROM, flash memory or external memory can be provided within the storage part 250.

The video receiving part 210 receives videos from the first imaging sensor 111 and the second imaging sensor 113 respectively. For understanding purposes, hereinafter, a first video is defined and used as a video captured by the first imaging sensor 111 and a second video is defined as a video captured by the second imaging sensor 113.

And, the video analyzing part 220 analyzes outlines and RGB values of a first video or of a second video, extracts fingers or a pointing stick from the video, recognizes movements of the fingers or the pointing stick, adjudges whether the movements of the fingers or the pointing stick correspond to the movement data stored in the storage part 250, and generates an output display control signal corresponding to the movements of the fingers or the pointing stick if the movements correspond to the movement data stored in the storage part 250. Here, the video analyzing part 220 finds a hand within a video using preset RGB values (e.g. values corresponding to a color of human skin) and preset shapes (e.g. a shape of human hand). And, the video analyzing part 220 finds a pointing stick within a video using preset shapes (e.g. a shape of a stick, which is long and thin). Here, it is preferred that a user uses a pointing stick only with a predetermined shape for having the video analyzing part 220 find a pointing stick with ease. And it is preferred that a pointing stick is a ballpoint pen or a wood stick with long and thin shape, however it is obvious that a pointing stick may be implemented in various specific forms.

And, the coordinate calculating part 230 receives a first video and a second video captured at the moment which the movements of the fingers or the pointing stick are inputted if the movements of the fingers or the pointing stick correspond to the movement data stored in the storage part 250. And the coordinate calculating part 230 extracts outlines and RGB values from the first video, determines locations of the left eye, the right eye and the fingers or a location of an end point of the pointing stick of the first video, and calculates 2D coordinate values of the left eye, the right eye and the fingers or of the end point of the pointing stick of the first video using the location(s). And the coordinate calculating part 230 also extracts outlines and RGB values from the second video, determines locations of the left eye, the right eye and the fingers or a location of an end point of the pointing stick of the second video, and calculates 2D coordinate values of the left eye, the right eye and the fingers or of the end point of the pointing stick of the second video using the location(s).

Thereafter, the coordinate calculating part 230 calculates 3D coordinate values of the right eye by trigonometry using the 2D coordinate values of the right eye of the first video and the second video, calculates 3D coordinate values of the left eye by trigonometry using the 2D coordinate values of the left eye of the first video and the second video, and calculates 3D coordinate values of the fingers or of the end point of the pointing stick by trigonometry using the 2D coordinate values of the fingers or of the end point of the pointing stick of the first video and the second video.

And, it is preferred that the coordinate calculating part 230 sets the 3D coordinate values of the right eye or of the left eye as a first point 101, sets the 3D coordinate values of the fingers or of the end point of the pointing stick as a second point 103, and determines a 3D mapping point 107 as a point at which the output display 100 and an extended line connecting the first point 101 and the second point 107 meet.

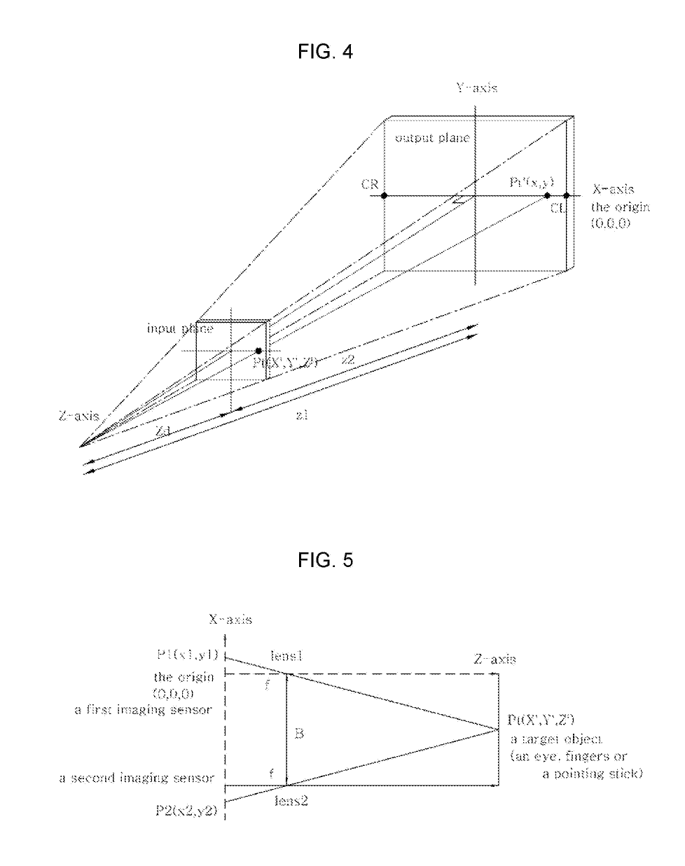

FIG. 4 is a diagram illustrating a way of determining a 3D mapping point according to a preferred embodiment of the present invention.

With reference to FIG. 4, the coordinate calculating part 230 translates 2D coordinate values of the target objects (in the present invention, the target objects are the left eye, the right eye and the fingers or the end point of the pointing stick) extracted from the first and the second video to 3D coordinate values including depth values of the target objects by trigonometry used in stereophotogrammetry technique.

Here, with reference to FIG. 5, the following equation 1 can be used for calculating 3D coordinate values by trigonometry used in stereophotogrammetry technique.

(Equation 1)

Z′=f−f*B/(x2−x1) (Equation 1-1)

X′=x1*(f−Z′)/f (Equation 1-2)

Y′=y1*(f−Z′)/f (Equation 1-3)

Here, 2D coordinate values of point P1 at which light from a target object is captured by the first imaging sensor is (x1, y1), 2D coordinate values of point P2 at which light from a target object is captured by the second imaging sensor is (x2, y2), the origin is at the center point of the first imaging sensor inside which the point P1 is located, and 3D coordinate values of point Pt at which the target object is located is (X′, Y′, Z′).

And here, B means distance between the center point of the first imaging sensor and the center point of the second imaging sensor. And f means focal length of the first and the second imaging sensor.

An exemplary description for determining a mapping point on an output display is provided hereunder with reference to FIG. 4.

First, using equation 1-1, z1 and z2 can be calculated. And, distance between an eye and fingers (the distance given as Zd) can be calculated using the following equation 2.

Zd=z2−z1 (Equation 2)

With reference to FIG. 4, assuming Pt(X′, Y′, Z′) as a point at which an end of a finger in an input plane (here, the input plane means a virtual screen for inputting) is located, Pt′(x, y) can be obtained by projecting Pt(X′, Y′, Z′) on an output plane (here, the output plane means an output display). Here, 2D coordinate values (x, y) of the point Pt′ can be calculated using equation 3.

Here, the location of the input plane can vary over time, thus a point on the input plane projecting on Pt′ can also move along the straight line connecting Pt and Pt′. However, 3D coordinate values of Pt, a 3D input information, can be obtained and transmitted to an output display because Z′ value of the point on the input plane projecting on Pt′ can be obtained. Therefore, the 3D input information of Pt can be used for obtaining 2D coordinate value of Pt′, a 2D input information, by projecting Pt on the output plane, and also can be used for other use.

x=X′*z2/Zd

y=Y′*z2/Zd (Equation 3)

The control signal transmitting part 240 transmits an output display control signal generated by the video analyzing part 220 and a mapping point generated by the coordinate calculating part 230 and obtained at the moment that the output display control signal is generated to the output device 300. Thereafter the output device 300 can change output displayed on the output display 100 according to the output display control signal and the mapping point transmitted from the control signal transmitting part 240.

As described above, the user interface apparatus according to the present invention has an advantage that inputting operations are possible under circumstances that an output device controlling an output display is located far away from a user or is located at a place which is not accessible by a user. And the user interface apparatus according to the present invention also has an advantage that the apparatus can be used by a person with a disability who has difficulty using an input device such as a mouse.

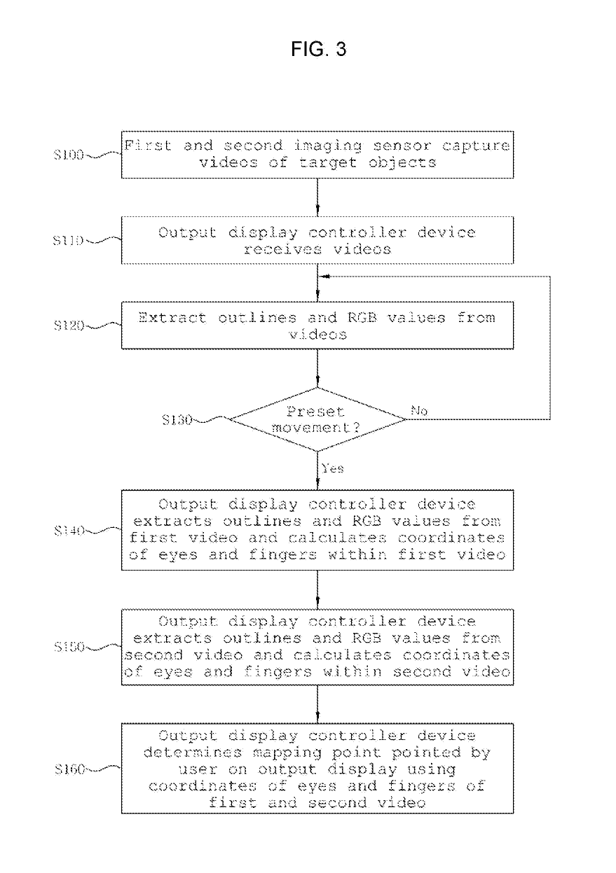

And, with reference to FIG. 3, a process flow of the user interface apparatus for 3D space-touch using multiple imaging sensors according to the present invention is explained hereinafter.

FIG. 3 is a diagram illustrating the process flow of the user interface apparatus for 3D space-touch using multiple imaging sensors according to a preferred embodiment of the present invention.

First, a first imaging sensor 111 and a second imaging sensor 113, installed respectively on one side and the other side of an output display 100, capture a video of a predetermined area and generate a first video and a second video respectively at step s100. Thereafter the first imaging sensor 111 and the second imaging sensor 113 transmit the first video and the second video to a video receiving part 210 within an output display controller device 200 respectively at step s110.

Thereafter, a video analyzing part 220 analyzes outlines and RGB values of the first video or the second video received at step s110 to extract fingers or a pointing stick, recognizes movements of the extracted fingers or the extracted pointing stick and adjudges whether the movements of the fingers or the pointing stick correspond to a preset movement controlling an output display 100 at step s130.

And, the video analyzing part 220 generates an output display control signal corresponding to the movements of the fingers or the pointing stick, if the movements of the fingers or the pointing stick correspond to the preset movement controlling an output display as a result of step s130.

Meanwhile, if the movements of the fingers or the pointing stick correspond to the preset movement controlling an output display as a result of step s130, a coordinate calculating part 230 receives a first video and a second video captured at the moment which the movements of the fingers or the pointing stick are inputted, extracts outlines and RGB values from the first video, determines locations of the left eye, the right eye and the fingers or a location of an end point of the pointing stick and calculates 2D coordinate values of the left eye, the right eye and the fingers or of the end point of the pointing stick of the first video using the location(s) at step s140. And the coordinate calculating part 230 extracts outlines and RGB values from the second video, determines locations of the left eye, the right eye and the fingers or a location of an end point of the pointing stick and calculates 2D coordinate values of the left eye, the right eye and the fingers or of the end point of the pointing stick of the second video using the location(s) at step s150.

Thereafter, the coordinate calculating part 230 calculates 3D coordinate values of the right eye by trigonometry using the 2D coordinate values of the right eye of the first video and the second video, calculates 3D coordinate values of the left eye by trigonometry using the 2D coordinate values of the left eye of the first video and the second video, and calculates 3D coordinate values of the fingers or of the end point of the pointing stick by trigonometry using the 2D coordinate values of the fingers or of the end point of the pointing stick of the first video and the second video.

And, the coordinate calculating part 230 sets the 3D coordinate values of the right eye or of the left eye as a first point, sets the 3D coordinate values of the fingers or of the end point of the pointing stick as a second point, and determines a mapping point as a point at which the output display and an extended line connecting the first point and the second point meet, at s160.

Thereafter, the control signal transmitting part 240 transmits the output display control signal, the mapping point and a 3D input information extracted from the fingers or the pointing stick to the output device 300.

As described above, the present invention can provide a user interface apparatus and method for 3D space-touch using multiple imaging sensors which can control an output display and provide a 3D input information without a separate input device, with an output display controller device analyzing a video data captured by the imaging sensors installed at one side and the other side of the output display, by the output display controller device generating an output display control signal and a mapping information and transmitting the signal and the mapping information to the output device if a user's motion is determined to be a motion of inputting a controlling signal (such as an act of double-clicking a part of the output display) corresponding to the output display control signal using the user's hand or a pointing stick (such as a ballpoint pen, a wood stick, etc.), thereby making users interested and providing users with convenience.

It will be understood by those having ordinary skill in the art to which the present invention pertains that the present invention may be implemented in various specific forms without changing the technical spirit or indispensable characteristics of the present invention. Accordingly, it should be understood that the above-mentioned embodiments are illustrative and not limitative from all aspects. The scope of the present invention is defined by the appended claims rather than the detailed description, and the present invention induced from the meaning and scope of the appended claims and their equivalents.

What is claimed is:

1. A user interface apparatus for three dimensional (3D) space-touch using multiple imaging sensors, the apparatus comprising:
a first imaging sensor installed on one side of an output display capturing a video of a predetermined area, generating a first video, and transmitting the first video to an output display controller device;
a second imaging sensor installed on the other side of the output display capturing a video of a predetermined area, generating a second video, and transmitting the second video to the output display controller device;
a storage part storing pointing stick movement data and finger movement data controlling an output display; and
an output display controller device, wherein:
the output display controller device performs operations, the operations comprising: receiving the first video and the second video; analyzing outlines and RGB values of the first video or the second video to extract fingers or a pointing stick; recognizing movements of the extracted fingers or the extracted pointing stick; adjudging whether the movements of the fingers or the pointing stick correspond to the movement data stored in the storage part; generating an output display control signal corresponding to the movements of the fingers or the pointing stick if the movements of the fingers or the pointing stick correspond to the movement data stored in the storage part; extracting eyes and the fingers or extracting the pointing stick from a first video and a second video respectively; determining a mapping point pointed by a user on an output display based on locations of the eyes and the fingers or a location of the pointing stick; and transmitting the output display control signal, the mapping point and a 3D input information extracted from the fingers or the pointing stick to an output device; and
the output display controller device is characterized by:
if the movements of the fingers or the pointing stick correspond to the movement data stored in the storage part, receiving a first video and a second video captured at the moment which the movements of the fingers or the pointing stick are inputted; extracting outlines and RGB values from the first video, determining locations of the left eye, the right eye and the fingers or a location of an end point of the pointing stick of the first video, and calculating two dimensional (2D) coordinate values of the left eye, the right eye and the fingers or of the end point of the pointing stick of the first video using the locations of the left eye, the right eye and the fingers or the location of the end point of the pointing stick of the first video; extracting outlines and RGB values from the second video, determining locations of the left eye, the right eye and the fingers or a location of an end point of the pointing stick of the second video, and calculating 2D coordinate values of the left eye, the right eye and the fingers or of the end point of the pointing stick of the second video using the locations of the left eye, the right eye and the fingers or the location of the end point of the pointing stick of the second video; calculating 3D coordinate values of the right eye by trigonometry using the 2D coordinate values of the right eye of the first video and the second video, calculating 3D coordinate values of the left eye by trigonometry using the 2D coordinate values of the left eye of the first video and the second video, and calculating 3D coordinate values of the fingers or of the end point of the pointing stick by trigonometry using the 2D coordinate values of the fingers or of the end point of the pointing stick of the first video and the second video; setting the 3D coordinate values of the right eye or of the left eye as a first point, setting the 3D coordinate values of the fingers or of the end point of the pointing stick as a second point, and determining a mapping point as a point at which the output display and an extended line connecting the first point and the second point meet.

2. An input method for a user interface apparatus for 3D space-touch using multiple imaging sensors, the input method comprising the steps of:
(a) a first imaging sensor and a second imaging sensor, installed respectively on one side and the other side of an output display, capturing a video of a predetermined area, generating a first video and a second video respectively, and transmitting the first video and the second video to an output display controller device respectively;
(b) the output display controller device analyzing outlines and RGB values of the first video or the second video received at step (a) to extract fingers or a pointing stick;
(c) the output display controller device recognizing movements of the fingers or the pointing stick extracted at step (b) and adjudging whether the movements of the fingers or the pointing stick correspond to a preset movement controlling an output display;
(d) the output display controller device generating an output display control signal corresponding to the movements of the fingers or the pointing stick, if the movements of the fingers or the pointing stick correspond to the preset movement controlling an output display as a result of step (c);
(e) the output display controller device receiving a first video and a second video captured at the moment which the movements of the fingers or the pointing stick are inputted, analyzing outlines and RGB values of the first video and the second video, determining locations of the eyes and the fingers or a location of an end point of the pointing stick, and determining a 3D mapping point pointed by a user based on the locations of the eyes and the fingers or the location of the end point of the pointing stick, if the movements of the fingers or the pointing stick correspond to the preset movement controlling an output display as a result of step (c); and
(f) the output display controller device transmitting the output display control signal, the mapping point and a 3D input information extracted from the fingers or the pointing stick to an output device,
and the step (e) comprising the steps of:
(e1)) the output display controller device receiving a first video and a second video, if the movements of the fingers or the pointing stick correspond to the preset movement controlling an output display as a result of step (c);
(e2) the output display controller device extracting outlines and RGB values from the first video and the second video received at step (e1), and determining locations of the left eye, the right eye and the fingers or a location of an end point of the pointing stick of each video;
(e3) the output display controller device calculating 2D coordinate values of the left eye, the right eye and the fingers or of the end point of the pointing stick of the first video using the locations of the left eye, the right eye and the fingers or the location of the end point of the pointing stick of the first video determined at step (e2), and calculating 2D coordinate values of the left eye, the right eye and the fingers or of the end point of the pointing stick of the second video using the locations of the left eye, the right eye and the fingers or the location of the end point of the pointing stick of the second video determined at step (e2);
(e4) the output display controller device calculating 3D coordinate values of the right eye by trigonometry using the 2D coordinate values of the right eye of the first video and the second video, calculating 3D coordinate values of the left eye by trigonometry using the 2D coordinate values of the left eye of the first video and the second video, and calculating 3D coordinate values of the fingers or of the end point of the pointing stick by trigonometry using the 2D coordinate values of the fingers or of the end point of the pointing stick of the first video and the second video; and
(e5) the output display controller device setting the 3D coordinate values of the right eye or of the left eye as a first point, setting the 3D coordinate values of the fingers or of the end point of the pointing stick as a second point, and determining a mapping point as a point at which the output display and an extended line connecting the first point and the second point meet.
